(19) United States
(12) Patent Application Publication
(10) Pub. No.: US 2011/0025625 A1
(43) Pub. Date: Feb. 3, 2011

(54) MOBILE ELECTRONIC DEVICE

(75) Inventor: Kenichi HIRAKO, Daito-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/841,118

(22) Filed: Jul. 21, 2010

(30) Foreign Application Priority Data
Jul. 29, 2009 (JP) 2009-176312

(51) Int. Cl. G06F 3/041; G09G 5/00

(52) U.S. Cl. 345/173; 345/1.1

(57) ABSTRACT

A mobile electronic device and a method for controlling a mobile electronic device are disclosed. The mobile electronic device comprises a first display and a second display. A data item displayed on the first display is displayed on the second display in response to a state determined by a state determination module. The method comprises determining a state based on a rotational direction and/or positional relation of the mobile electronic device. The method further comprises selecting a display for displaying data based on the state.

### CROSS-REFERENCE TO RELATED APPLICATION

The present application claims priority under 35 U.S.C. §119 to Japanese Patent Application No. 2009-176312, filed on Jul. 29, 2009, entitled “MOBILE TERMINAL DEVICE”. The content of which is incorporated by reference herein in its entirety.

### FIELD

Embodiments of the present disclosure relate generally to mobile electronic devices, and more particularly relate to a mobile electronic device comprising a display.

### BACKGROUND

Mobile electronic book readers may store book data in a storage device, and allow the book data to be displayed on a display module. Such mobile electronic book readers may be capable of retaining a large volume of data comparable to a very large number of paper books that may not be easy to carry. The book data may be distributed to the mobile electronic book readers via mobile communications such as via a mobile phone.

In conventional mobile electronic book readers, however, a user can presses a next page key or a previous page key among various operation keys to change a page to be displayed. When he/she wishes to skip a plurality of pages forward or backward to read a particular page, he/she can press the page key several times. This entails an approach that can be substantially more complicated than just flipping pages of a paper book.

A dual-screen electronic display device may have a rotary switch near a hinge member, which couples two screens within the reach of a user's fingers to allow the user to press the rotary switch with her/his finger to change pages while holding the dual-screen electronic display device in one hand. When the rotary switch is used to change the pages, the user's finger may accidentally touch the rotary switch, changing pages unintentionally. Likewise, when pages are turned forward or backward by pressing operation keys, some irrelevant operation keys nearby may be inadvertently touched. As a result, an unwanted operation may be carried out.

### SUMMARY

A mobile electronic device and method operable to select a display for a display item based on a determined state is disclosed. The mobile electronic device comprises a first display and a second display. A data item displayed on the first display is displayed on the second display in response to a state determined by a state determination module.

A first embodiment comprises a mobile electronic device. The mobile electronic device comprises a first display module, and a second display module operable to change a relative position to the first display module. The mobile electronic device further comprises a state determination module operable to determine a state of the mobile electronic device, and a control module. The control module is operable to display second page data on the second display module based on the state if first page data is displayed on the first display module.

A second embodiment comprises a method of controlling a mobile electronic device. The method comprises determining a state based on a rotational direction and positional relation of the mobile electronic device, and selecting a display for displaying data based on the state.

A third embodiment comprises a computer readable medium comprising program code for operating an image display device. The program comprises code for determining a state based on a rotational direction and positional relation of the mobile electronic device, and selecting a display for displaying data based on the state.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure. The drawings are not necessarily made to scale.

FIG. 1A is an illustration of a perspective view of an exemplary fold-type mobile electronic device in a closed state according to an embodiment of the disclosure.

FIG. 1B is an illustration of an exemplary perspective view of the mobile electronic device of FIG. 1A in an open state.

FIG. 1C is an illustration of an exemplary perspective view of the mobile electronic device of FIG. 1A closed with its two display modules exposed on respective sides.

FIG. 1D is an illustration of an exemplary perspective view of the mobile electronic device of FIG. 1C showing a rotated position thereof.

FIG. 2 is an illustration of an exemplary schematic functional block diagram of an electronic mobile device according to an embodiment of the disclosure.

FIG. 3 is an illustration of an exemplary mobile electronic device showing an X-axis direction, a Y-axis direction, and a Z-axis direction thereof.

FIG. 4 is an illustration of an exemplary flow chart showing a condition determination process according to an embodiment of the disclosure.

FIG. 5 is an illustration of a data configuration of a book data information table stored in a storage module according to an embodiment of the disclosure.

FIG. 6 is an illustration of a mode of usage when data of a particular electronic book is selected from data of a plurality of electronic books according to an embodiment of the disclosure.

FIG. 7 is an illustration of an exemplary flow chart showing a process for displaying a next page according to an embodiment of the disclosure.

FIGS. 8-9 is an illustration of a flow chart showing a rotational direction dependent process according to an embodiment of the disclosure.

FIGS. 10A-10C are illustrations of image data displayed on a mobile electronic device according to an embodiment of the disclosure.

FIGS. 11A and 11B are illustrations of image data displayed on a mobile electronic device according to an embodiment of the disclosure.

FIG. 12A is an illustration of an exemplary perspective view of a mobile electronic device according to an embodiment of the disclosure.

FIG. 12B an illustration of the exemplary mobile electronic device of FIG. 12A rotated rightward by 45° according to an embodiment of the disclosure.

FIG. 12C is an illustration of the exemplary electronic device of FIG. 12B rotated back to its original position according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding field, background, summary or the following detailed description. The present disclosure should be accorded scope consistent with the claims, and not limited to the examples described and shown herein.

Embodiments of the disclosure are described herein in the context of one practical non-limiting application, namely, a mobile electronic device. Embodiments of the disclosure, however, are not limited to such mobile electronic devices, and the techniques described herein may also be utilized in other applications. For example, embodiments may be applicable to mobile phones, digital books, digital cameras, electronic game machines, digital music players, personal digital assistance (PDA), personal handy phone system (PHS), lap top computers, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

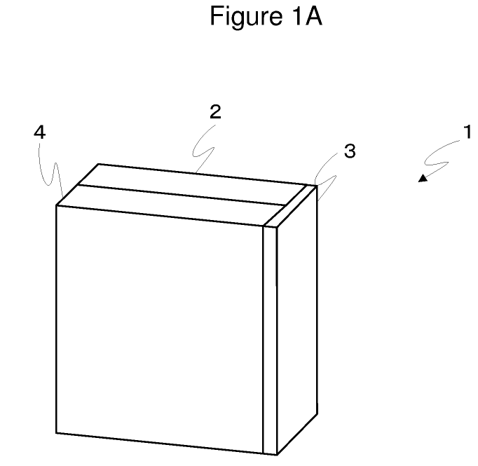

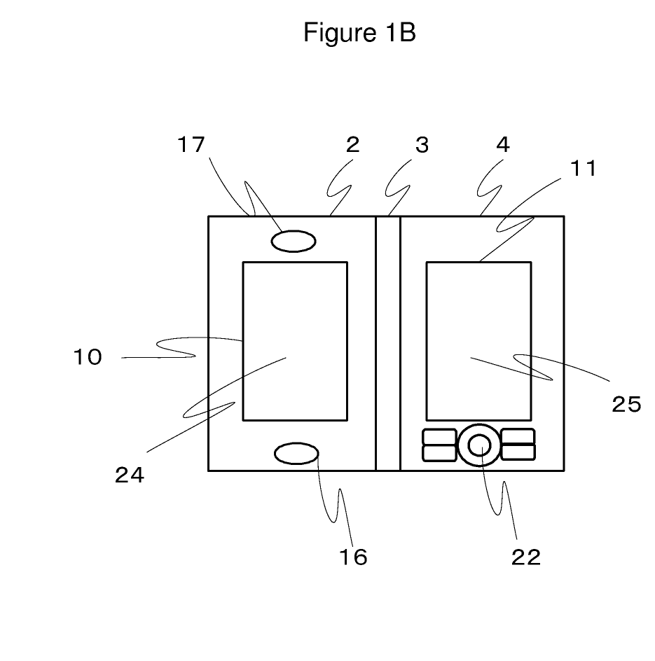

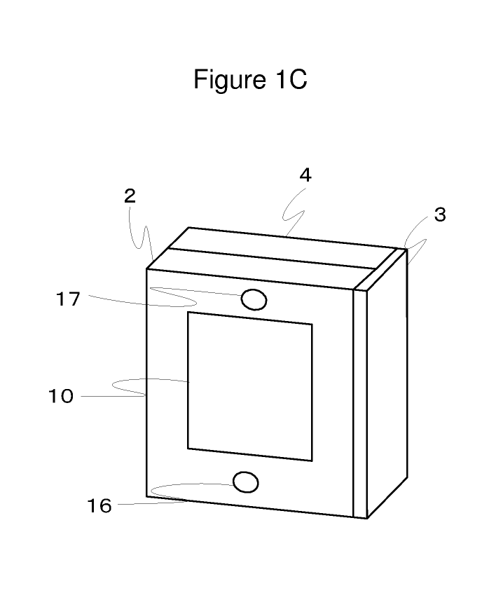

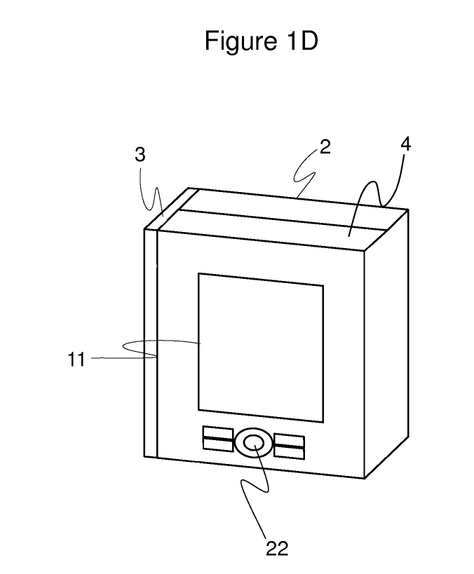

FIGS. 1A to 1D are illustrations of an exemplary fold-type mobile electronic device 1 (mobile phone1) according to an embodiment of the disclosure. FIG. 1A is an illustration of a perspective view of the exemplary mobile phone1 in a closed state. FIG. 1B is an illustration of an exemplary perspective view of the mobile phone 1 of FIG. 1A in an open state. FIG. 1C is an illustration of an exemplary perspective view of the mobile phone 1 of FIG. 1A in the closed with its two display modules exposed on their respective sides. FIG. 1D is an illustration of an exemplary perspective view of the mobile phone 1 of FIG. 1C showing a rotated position thereof.

The mobile phone 1 comprises a first housing 2, a second housing 4, and a hinge member 3 coupling the first housing 2 and the second housing 4 to each other. The first housing 2 may comprise a display module 10 comprising a touch panel 24, a speaker 17, and a microphone 16. The second housing 4 may comprise a display module 11 comprising a touch panel 25, and a key input module 22.

As shown in FIG. 1A, the first housing 2 and the second housing 4 are in the closed state (closed position). In the closed position, the display module 10 of the first housing 2 and the display module 11 of the second housing 4 are in contact with each other.

As shown in FIG. 1B, the first housing 2 and the second housing 4 are moved away from each other to provide an open state (open position). More specifically, the second housing 4 rotates by approximately 180 degrees away from the first housing 2 to change a state of the mobile phone 1 from a closed position to an open position. In the open position, the display module 10 of the first housing 2 and the display module 11 of the second housing 4 can be simultaneously viewed from a single viewpoint. In this manner, the display module 10 and display module 11 are in a simultaneously visible position.

As shown in FIG. 1C, the first housing 2 and the second housing 4 are positionally rotated relative to each other (rotated position). More specifically, the second housing 4 is rotated by approximately 360 degrees about the hinge member 3 relative to the first housing 2 to change a state of the mobile phone 1 from the closed position to the rotated position. In the rotated position, the display module 10 of the first housing 2 and the display module 11 of the second housing 4 can not be simultaneously viewed in a line of sight from a single viewpoint. As shown in FIG. 1C, the display module 10 of the first housing 2 is viewable, whereas the display module 11 of the second housing 4 is out of sight.

FIG. 1D is an illustration of a perspective view of the exemplary mobile phone 1 of FIG. 1C showing the rotated position thereof. In the rotated position shown in FIG. 1D, the display module 11 of the second housing 4 is viewable, whereas the display module 10 of the first housing 2 is out of sight.

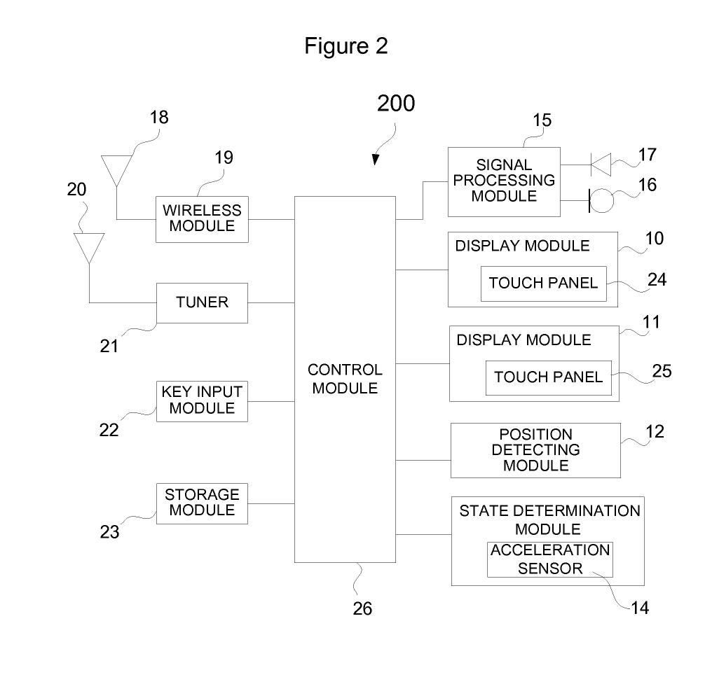

FIG. 2 is an illustration of an exemplary schematic functional block diagram of the mobile phone 1 according to an embodiment of the disclosure The mobile phone 1 comprises an antenna 18, a wireless module 19, an antenna 20, a tuner 21, a key input module 22, a signal processing module 15, a microphone 16, a speaker 17, a storage module 23, a display module 10, a display module 11, a state determination module 13, a position detection module 12, and a control module 26.

The wireless module 19 modulates and demodulates signals transmitted and received via the antenna 18. The wireless module 19 modulates a transmitting signal from the control module 26 as a radio signal to the base station through the antenna 18, and demodulates a radio signal received from the base station through the antenna 18. The control module 26 receives the demodulated signal form the wireless module 19.

The tuner 21 comprises the antenna 20. The tuner 21 can receive commands by the control module 26 to receive a particular signal, such as but without limitation, a data signal, an electronic book, a television program, and the like. In this manner, the tuner 21 can receive at least one digital signal via the antenna 20. The tuner 21 then acquires the signal, and outputs the data to the control module 26.

The key input module 22 is used to make, for example but without limitation, telephone calls, input data, transmit data, input commands to operate functions of the mobile phone 1, and the like. The key input module 22 accepts an operation command inputted by a user, and outputs an operation command information relevant to the accepted operation command to the control module 26. The key input module 22 comprises, for example but without limitation, a call start key, a call end key, a select key, a mail application command key, a command key for reception of TV broadcast, keys through which numerals and texts can be inputted, and the like.

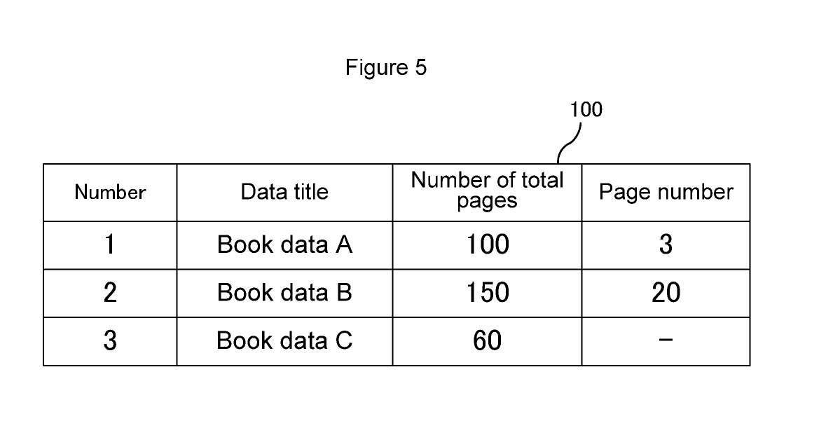

The storage module 23 is operable to store various kinds of data used for various processes of the mobile phone 1. In practical embodiments, the storage module 23 may comprise, for example but without limitation, a non-volatile storage device (non-volatile semiconductor memory, hard disk device, optical disk device, and the like), a random access storage device (for example, SRAM, DRAM), or any other form of storage medium known in the art. For example, the storage module 23 may store, image data, music data, received mail data, book data, and the like. The book data comprises data of books, including data of a plurality of pages arranged in a given order. The page data comprises such data as text data and image data. The book data is explained in more detail in the context of discussion of FIG. 5 below. The storage module 23 may also store a computer program, which is executed by the control module 23, an operating system, an application program, tentative data used in executing a program processing, and the like. The storage module 23 may be coupled to the control module 26 such that the control module 26 can read information from and write information to storage module 23. As an example, the control module 26 and the storage module 23 may reside in their respective ASICs. The storage module 23 may also be integrated into the control module 26. In an embodiment, the storage module 23 may comprise a cache memory for storing temporary variables or other intermediate information during execution of instructions to be executed by the control module 26. The storage module 23 may also comprise non-volatile memory for storing instructions to be executed by the control module 26.

The control module 26 controls an overall operation of the mobile phone 1. For example, the control module 26 can control the operation by detecting information inputted via the key input module 22 and the touch panels 24 and 25. For another example the control module 26 may control operations of the mobile phone 1 so that processes of the mobile phone 1 are suitably performed such that various processing are performed by proper procedures in response to manipulation of the key input module 22, and the touch panels 24 and 25. These processes comprise, for example but without limitation, executing a telephone call function, activating the electronic mail function, displaying the page image based on the page data on the display module 10/11, selecting a book data, and the like. The control module 26 also controls access to the storage module 23 such as access to the book data, image data, music data, received mail data, and the like. The control module 26 can control transmission/reception of signals at the wireless module 19 to perform the telephone call function, the electronic mail function, to receive the book data, and the like. For another example, the control module 26 can control display of the page image data on the display module 10/11 based on state determination results received from the state determination module 13, as explained in more detail below.

The control module 26 may comprise a computer CPU (microprocessor) or another processor for performing a process based on a program (operating system, application program, etc.) stored in the storage module 23. The control module 26 may read instruction code sequentially from programs such as the operating system and the application program, which are stored in the storage module 23, and perform the programs. For example, displaying of the page image data stored in the storage module 23 may be realized on the computer by one or a plurality of programs, or may be at least partially realized by hardware.

The signal processing module 15 receives an audio signal from the microphone 16, and processes the audio signal for transmission via the wireless module 19. The signal processing module 15 receives the audio signal from, e.g., the antenna 18 via the wireless module 19, electronic mail, book data, and the like, and outputs the audio signal to the speaker 17 and to the control module 26. The signal processing module 15 carries out a process for outputting a voice signal output from the speaker 17 and receiving a voice signal input in the microphone 16. In this manner, the signal processing module 15 amplifies the analog voice input received from the microphone 16, and carries out an analog/digital conversion to obtain a digital voice input. The signal processing module 15 applies a signal processing technique such as an encoding or the like to the digital voice input to obtain an encoded digital voice input, and sends the encoded digital voice input to the control module 26. The signal processing module 15 is also operable to apply signal processing to digital voice data supplied from the control module 26. In this manner, the control module 26 performs decoding, digital/analog conversion, and amplification to convert the digital voice data to an analog voice signal for output to the speaker 17.

The microphone 16 outputs voice or sound inputted thereto to the signal processing module 15 in the form of the audio signal.

The speaker 17 outputs the audio signal processed by the signal processing module 15 or audio data received from the control module 26 in the form of voice or sound.

The display module 10 comprises the touch panel 24 and displays an image based on the data received from the control module 26. The touch panel 24 accepts a user's input operation to input and transmit data, and input operation commands for functions provided in the mobile phone 1. The touch panel 24 accepts the operation command, and the display module 10 outputs operation command information to the control module 26 in response to the accepted operation command. The touch panel 24 may be formed by a liquid crystal panel (LCD). For example, the touch panel 24 may be formed by an organic electro-luminescence (OEL) panel. Various kinds of information can be displayed on the display screen of the touch panel 24 via an image/video signal supplied from the control module 26.

The display module 11 comprises a touch panel 25 and displays an image based on the data received from the control module 26. The touch panel 25 accepts the user's input operation as well to input and transmit data, and input operation commands for functions provided in the mobile phone 1. The touch panel 25 accepts the operation command, and the display module 11 outputs operation command information to the control module 26 in response to the accepted operation command. The touch panel 25 may be made from the same material as the touch panel 24 explained above.

The position detection module 12 detects a relative position of the second housing 4 to the first housing 2 to detect whether the mobile phone 1 is at the closed position, the open position, or the rotated position. According to an embodiment, the position detection module 12 comprises a first switch and a second switch. The first switch is rendered connected when the mobile phone 1 is at the closed position, and rendered disconnected when the mobile phone 1 is at the open position. The second switch is rendered connected when the mobile phone1 is at the rotated position, and rendered disconnected when the mobile phone1 is at the open position. The relative positions of the first housing 2 and the second housing 4 to each other can be determined by detecting the connection states of the first switch and the second switch.

In this manner, if the first switch is connected, the position detection module 12 detects the closed position. If the second switch is connected, the position detection module 12 detects the rotated position. If the first switch and the second switch are both disconnected, the mobile phone 1 stays at the open position. The position detection module 12 outputs the detected position to the control module 26. The first switch and/or the second switch may be, for example but without limitation, a magnetic sensor, or the like. In an embodiment, the magnetic sensor is provided in both of the first housing 2 and the second housing 4. In this manner, an electrical signal flow is generated in response to coupling the magnetic sensors to each other when the mobile phone1 is at the closed position. Whereas, electrical signal flow is not generated when the mobile phone1 is at the open position where the magnetic sensors are not coupled to each other.

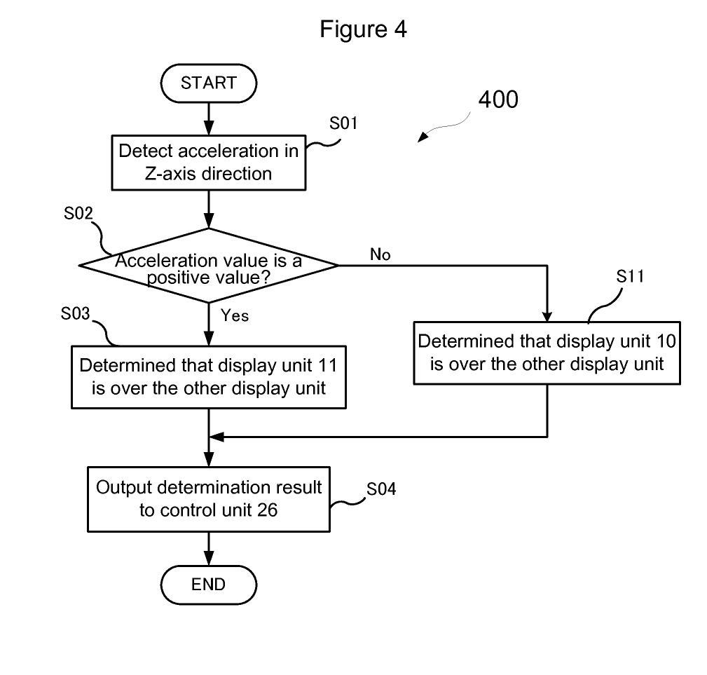

The state determination module 13 is operable to determine a state of the mobile phone 1. The state may comprises a positional relation and/or a rotational direction of the mobile phone 1 as explained in more detail below. The state determination module 13 comprises an acceleration sensor 14 configured to detect an acceleration of the mobile phone 1 to determine a rotational direction and/or positional relation thereof. When the mobile phone 1 is at the rotated position, the state determination module 13 determines which of the display module 10 and the display module 11 is on top of the other. When the display module 10 is on top of the display module 11, the display module 10 faces the user. When the display module 11 is on top of the display module 10, the display module 11 faces the user. Determination of a positional relationship of the display modules 10/11 using the state determination module 13 is described in more detail below in the context of discussion of FIG. 4.

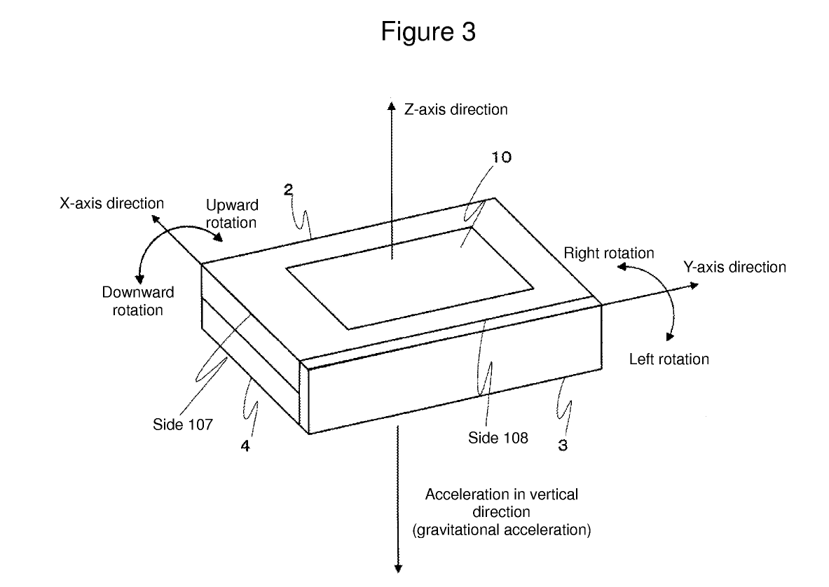

FIG. 3 is an illustration of an X-axis direction, a Y-axis direction and a Z-axis direction of the mobile phone 1. The acceleration sensor 14 detects a gravitational acceleration (acceleration in vertical direction). The state determination module 13 calculates accelerations components of the gravitational acceleration in the X-axis direction, Y-axis direction and Z-axis direction. The X-axis direction is substantially parallel to a side 107 of the first housing 2. The Y-axis direction is substantially perpendicular to the X-axis direction and is substantially parallel to a side 108 of the first housing 2. The Z-axis direction is substantially perpendicular to a plane formed by the X-axis direction and the Y-axis direction. A direction of the Z-axis direction heading toward the first housing 2 and away from the second housing 4 represents a positive direction, and a direction of the Z-axis direction heading toward the second housing 4 and away from the first housing 2 represents a negative direction.

FIG. 4 is an illustration of an exemplary flow chart showing a state determination process 400 that can be carried out by the state determination module 13 according to an embodiment of the disclosure. The various tasks performed in connection with process 400 may be performed by software, hardware, firmware, a computer-readable medium having computer executable instructions for performing the process method, or any combination thereof. The process 400 may be recorded in a computer-readable medium such as a semiconductor memory, a magnetic disk, an optical disk, and the like, and can be accessed and executed, for example, by a computer CPU in which the computer-readable medium is stored. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein. For illustrative purposes, the following description of process 400 may refer to elements mentioned above in connection with FIGS. 1-3. Process 400 may have functions, material, and structures that are similar to the embodiments shown in FIGS. 1-3. Therefore common features, functions, and elements may not be redundantly described here.

Process 400 may begin by the state determination module 13 detecting the acceleration in the Z-axis direction (task S01). Process 400 may then continue, by the state determination module 13 determining whether the acceleration value is a positive value (inquiry task S02). In this manner, the state determination module 13 determines that the display module 10 is on top of (over) the display module 11 (task S11), if the acceleration in the Z-axis direction results in a negative value (“NO” branch of inquiry task S02). Otherwise, the state determination module 13 determines that the display module 11 is on top of (over) the display module 10 (S03), if the acceleration in the Z-axis direction results in a positive value (“YES” branch of the inquiry task S02). The state determination module 13 outputs the determination result to the control module 26 (task S04), and the process 400 ends.

When the mobile phone 1 changes position from the closed position or from the open position to the rotated position, the control module 26 may display the page image of book data selected by a user from all of the book data stored in the storage module 23 on the display module 10 or the display module 11. The control module 26 displays the page image on the display module 10 if the state determination module 13 determines that the display module 10 is over the display module 11. Otherwise, the control module 26 displays the page image on the display module 11 if the state determination module 13 determines that the display module 11 is over the display module 10.

If the state determination module 13 determines that the display module 11 is over the display module 10 while the display module 10 is displaying the page image, the control module 26 displays a next page image that follows the current page image of the display module 10 on the display module 11. If the state determination module 13 determines that the display module 10 is over the display module 11 while the display module 11 is displaying the page image, the control module 26 displays a next page image that follows the current page image of the display module 11 on the display module 11.

For example, if the state determination module 13 determines that the display module 11 is over the display module 10 while the display module 10 is displaying the page image based on the page data of page 3, for example, the control module 26 displays a page image based on page data of page 4 on the display module 10.

If the mobile phone 1 changes position from the rotated position to the open position or to the closed position, the control module 26 may cease to display the page image, in which case the control module 26 stores a page number relevant to the page image displayed immediately before the display of the page image is discontinued in the storage module 23.

With the mobile phone 1 at the rotated position, the control module 26 rejects any inputs from the touch panels provided in the display module 10 and the display module 11.

The control module 26 may turn off a backlight (not shown) of the display module 11 as long as the page image is displayed on the display module 10, or may turn off a backlight of the display module 10 as long as the page image is displayed on the display module 11. In this manner, the control module turns off the backlight and renders the inputs through the touch panels 24/25 and key input module enabled or disabled. Alternatively, a light control module (not shown) and an operation control module (not shown) may be provided, where the light control module puts the backlight off, and the operation control module renders the inputs through the touch panels 24/25 and key input module enable or disable.

FIG. 5 is an illustration of a data configuration of a book data information table 100 stored in the storage module 23 according to an embodiment of the disclosure module. The book data information table 100 associates titles of the book data and the page data with each other. The book data information table 100 may comprise, for example but without limitation, a number column comprising record numbers, a data title column comprising data titles, a total number of pages column comprising total numbers of pages, a page number column comprising page numbers, and the like.

Each of the data titles denotes a title of the book data. The total number of pages denotes a total number of pages of the page data in the book data. Each of the page numbers denotes a page number used when the book data is displayed on the display module 10/11 to identify which of the page data of the book data is chosen as data of a page image to be displayed. For example, a record number 1 of the number column indicates that book data A comprises page data of 100 pages, and a page image of a page data of page number 3 of the book data A is being displayed on the display module 10/11. The page number is updated based on information from the control module 26 when the display of the book data ends.

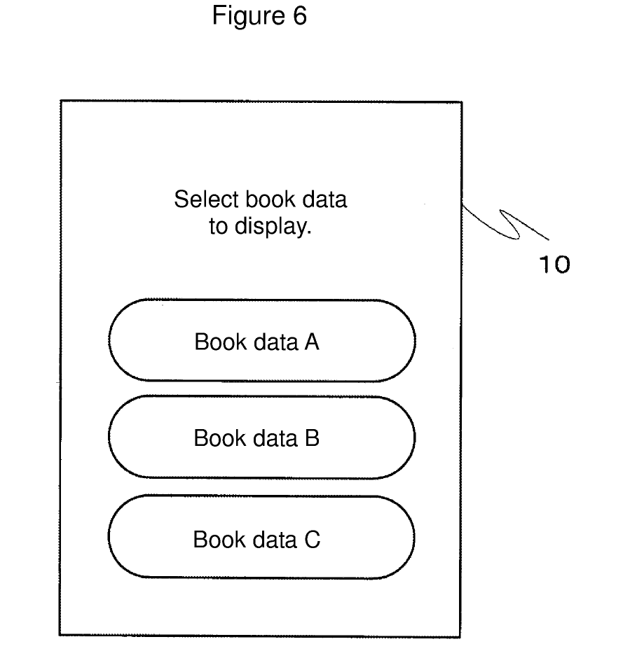

FIG. 6 illustrates a mode of usage when data of a particular electronic book is selected from data of a plurality of electronic books.

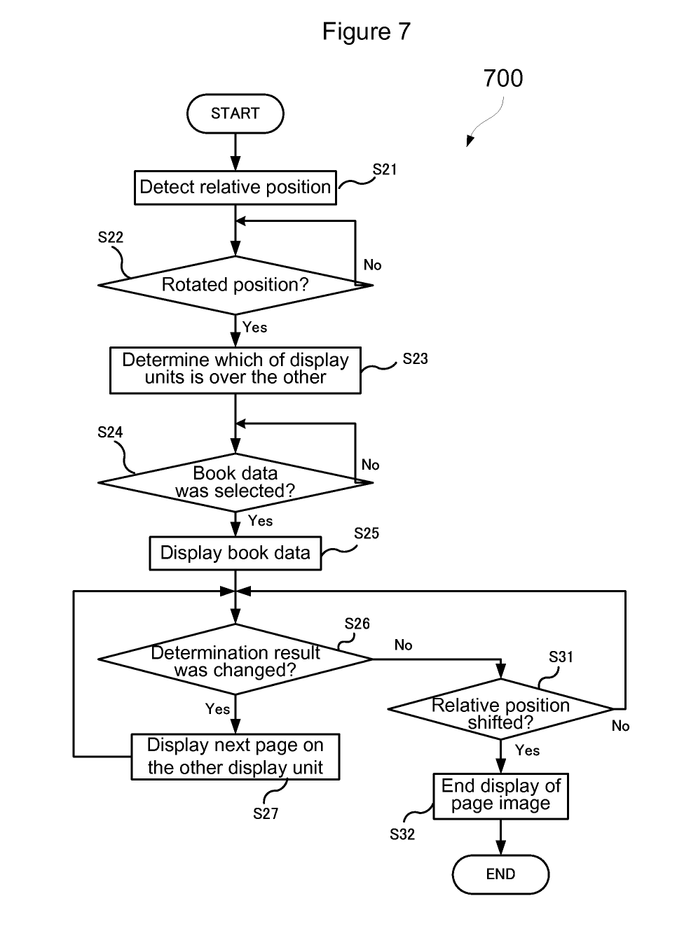

FIG. 7 is an illustration of an exemplary flow chart showing a process 700 for displaying a next page according to an embodiment of the disclosure. The various tasks performed in connection with process 700 may be performed by software, hardware, firmware, a computer-readable medium having computer executable instructions for performing the process method, or any combination thereof. The process 700 may be recorded in a computer-readable medium such as a semiconductor memory, a magnetic disk, an optical disk, and the like, and can be accessed and executed, for example, by a computer CPU in which the computer-readable medium is stored. It should be appreciated that process 700 may include any number of additional or alternative tasks, the tasks shown in FIG. 7 need not be performed in the illustrated order, and process 700 may be incorporated into a more comprehensive procedure or process having additional functionality not described in detail herein. For illustrative purposes, the following description of process 700 may refer to elements mentioned above in connection with FIGS. 1-6. In practical embodiments, portions of process 700 may be performed by different elements of the mobile phone 1 for displaying the next page, for example, the display module 10, the state determination module 13, the wireless module 19, the storage module 23, the control module 26, the signal processing module 15, the touch panels 25/26, the position detection module 12, key input module 22, etc. Process 700 may have functions, material, and structures that are similar to the embodiments shown in FIGS. 1-6. Therefore common features, functions, and elements may not be redundantly described here.

Process 700 may begin by the position detection module 12 detecting a position of the first housing 2 relative to the second housing 4 (task S21). If the position detection module 12 detects that the mobile phone 1 is at the rotated position (“YES” branch of the inquiry task S22), the state determination module 13 determines which of the display module 10 and the display module 11 is over the other (task S23). The process 600 may then continued by the control module 26 receiving a determination result from the state determination module 13, and displaying a list of titles of the book data stored in the storage module 23 accordingly. In this example, the display module 10 is over the display module 11 based on the determination result.

The process 700 may then continued by the control module 26 detecting whether a user selected a particular book data from the displayed book data by manipulating the touch panel 24 or the key input module 22 (inquiry task S24). Detecting that the user selected the particular book data (“YES” branch of the inquiry task S24), the control module 26 displays a page image of the selected book data on the display module 10 (task S25). The control module 26 obtains a relevant page number by referring to the book data information table 100 (FIG. 5), and displays on the display module 10 a page image based on page data indicated by the page number. For example, to display the book data A, a page image based on page data of page 3 of the book data A is displayed. For another example, to display the book data B, a page image based on page data of the page 20 is displayed. To display the book data C having no page number associated therewith, a page image based on the page data of page 1 is displayed.

After the book data is selected by the user, any inputs through the touch panels 24 and 25 and the key input module 22 are disabled. Thus configured, any unintended operation that may be triggered when the user's finger accidentally touches the keys can be averted while the display module is displaying the page image.

The process 700 may then continue by the control module 26 detecting whether or not the determination result obtained by the state determination module 13 is changed (inquiry task S26). If the determination result obtained by the state determination module 13 is changed (“YES” branch of the inquiry task S26), the control module 26 displays a next page image that follows the current image of the display module 10 on the display module 11 (task S27). The determination results may indicate, whether a positional relation such as the display module 10 over the display module 11 is changed to the positional relationship that the display module 11 is over the display module 10.

With no change detected in the determination result obtained by the state determination module 13 (“NO” branch of the inquiry task S26), the control module 26 detects whether or not the relative position of the second housing 4 to the first housing 2 has shifted (is changed) (task S31). If the relative position has shifted to any position other than the rotated position (“YES” branch of the inquiry task S31), the control module 26 ceases to display the page image (task S32), and process 700 ends.

The user can display the next page by rotating the mobile phone 1 by an angle of rotation, for example but without limitation, 180 degrees, and the like, without inputting any particular command to display the next page using either of the touch panels 24 and 25 or the key input module 22. In this manner, the user's finger can no longer accidentally touch the page-turner operation keys, thereby preventing the user from flipping pages unintentionally.

In an embodiment, a current page can proceed to a next page or go back to a previous page when the mobile phone 1 is rotated 180 degrees clockwise or counterclockwise.

In addition to the function described in the mobile phone 1, the state determination module 13 can determine a rotational direction of the mobile phone 1 using the acceleration sensor 14. More specifically, the state determination module 13 detects a change in rotational direction by detecting changes in the accelerations per unit time in the X-axis direction, Y-axis direction and Z-axis direction. There are at least four rotational directions detectable by the state determination module 13 comprising, for example but without limitation, leftward rotation, rightward rotation, upward rotation, downward rotation, and the like. As illustrated in FIG. 3, the leftward rotation is a counterclockwise rotation centered on the Y-axis direction, the rightward rotation is a clockwise rotation centered on the Y-axis direction, the upward rotation is a clockwise rotation centered on the X-axis direction, and the downward rotation is a counterclockwise rotation centered on the X-axis direction. The state determination module 13 outputs the determined rotation to the control module 26.

The control module 26 controls the display as follows based on the rotational direction of the mobile phone 1 determined by the state determination module 13. In this manner, when the state determination module 13 determines that the mobile phone 1 is rotated leftward, the control module 26 displays a next page image. If the state determination module 13 determines that the mobile phone 1 is rotated rightward, the control module 26 displays a previous page image. If the state determination module 13 determines that the mobile phone 1 is rotated upward, the control module 26 discontinues the ongoing display of a page image based on book data currently selected, and then displays a page image of book data stored immediately after the book data selected earlier. If the state determination module 13 determines that the mobile phone 1 is rotated downward, the control module 26 discontinues the ongoing display of a page image based on book data currently selected, and displays a page image of book data stored almost immediately before the book data selected earlier.

If the state determination module 13 determines that the mobile phone1 is rotated upward while the display module is displaying a page image based on page data of page 20 in the book data B, for example, the control module 26 displays a page image based on page data of page 1 in the book data C. Determining that the mobile phone 1 is rotated downward while the display module is displaying a page image based on page data of page 20 in the book data B, the control module 26 displays a page image based on page data of page 3 in the book data A.

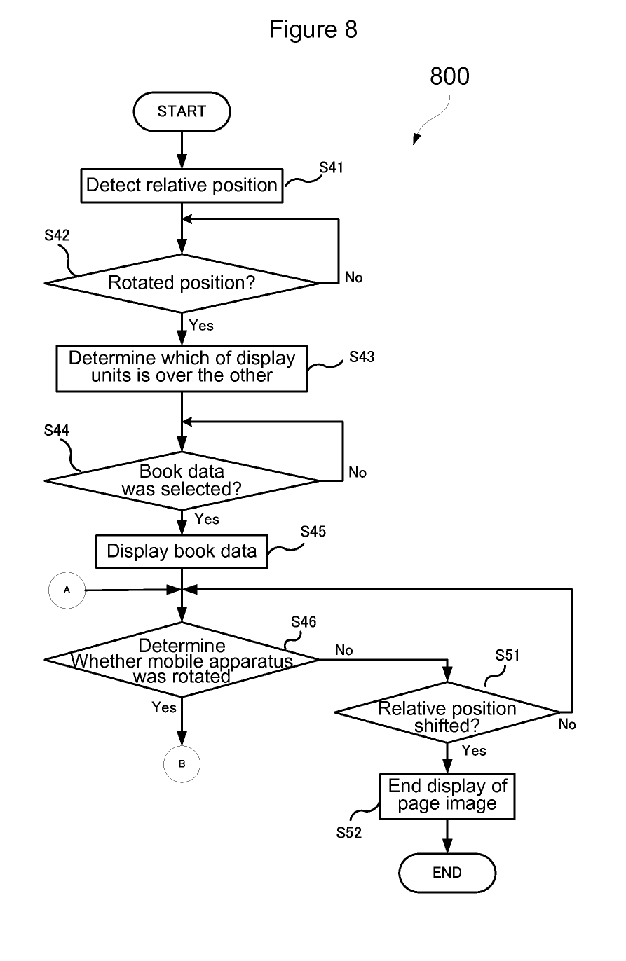

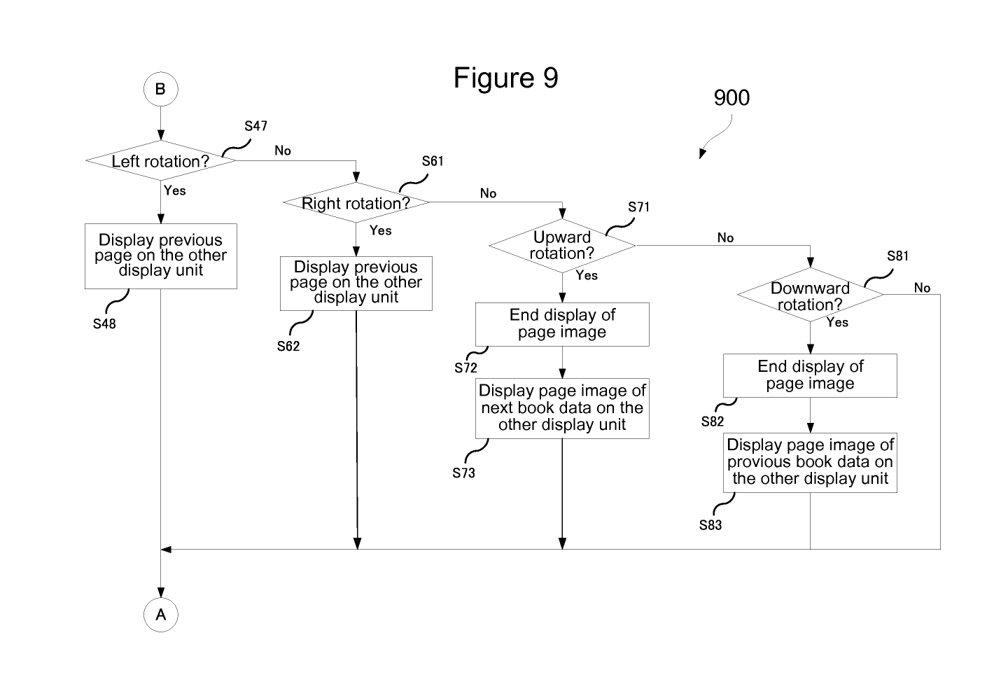

FIGS. 8-9 is an illustration of a flow chart showing a rotational direction dependent process 800 according to an embodiment of the disclosure. The various tasks performed in connection with process 800 may be performed by software, hardware, firmware, a computer-readable medium having computer executable instructions for performing the process method, or any combination thereof. The process 800 may be recorded in a computer-readable medium such as a semiconductor memory, a magnetic disk, an optical disk, and the like, and can be accessed and executed, for example, by a computer CPU in which the computer-readable medium is stored. It should be appreciated that process 800 may include any number of additional or alternative tasks, the tasks shown in FIG. 8 need not be performed in the illustrated order, and process 800 may be incorporated into a more comprehensive procedure or process having additional functionality not described in detail herein. For illustrative purposes, the following description of process 800 may refer to elements mentioned above in connection with FIGS. 1-7. In practical embodiments, portions of process 800 may be performed by different elements of the mobile phone 1 for displaying the next page, for example, the display module 10, the state determination module 13, the wireless module 19, the storage module 23, the control module 26, the signal processing module 15, the touch panels 25/26, the position detection module 12, key input module 22, etc. Process 600 may have functions, material, and structures that are similar to the embodiments shown in FIGS. 1-7. Therefore common features, functions, and elements may not be redundantly described here.

The position detection module 12 detects the relative positions of the first housing 2 and the second housing 4 to each other (task S41). If the position detection module 12 detects that the mobile phone 1 is at the rotated position (“YES” branch of the inquiry task S42), the state determination module 13 determines which of the display module 10 and the display module 11 is over the other (task S43). The control module 26 receives a determination result from the state determination module 13, and displays a list of titles of book data on one of the display modules over the other accordingly. In this example, the display module 10 is over the display module 11 based on the determination result.

The process 800 may then continue by the control module 26 detecting whether or not a user has selected a particular book data from the displayed book data by manipulating the touch panels 24 and 25 or the key input module 22 (inquiry task S44). If the control module 26 determines that the user has selected the particular book data, the control module 26 displays a page image of the selected book data (S45). In this example embodiment the book data B (FIG. 3) is selected by the user, and a page image based on page data of page 20 in the book data B is displayed on the display module 10.

After the book data B is selected by the user, any inputs through either of the touch panels 24 and 25 and the key input module 22 may be disabled. Thus configured, any unintended operation that may be triggered when the user's finger accidentally touches the keys can be averted while the display module is displaying the page image.

The process 800 may then continue by the state determination module 13 determining whether or not the mobile phone 1 is rotated (inquiry task S46). If the mobile phone 1 is determined to have been rotated leftward (“YES” branch of the inquiry task S47), the control module 26 displays a next page image on the display module 11 (task S48). More specifically, a page image based on page data of page 21 is displayed on the display module 11.

Determining that the mobile phone 1 is rotated rightward (“YES” branch of the inquiry task S61), the control module 26 displays a previous page image on the display module 11 (task S62). More specifically, a page image based on page data of page 19 is displayed on the display module 11.

If the state determination module 13 determines that the mobile phone1 is rotated upward (“YES” branch of the inquiry task S71), the control module 26 ceases to display the page image of the book data B (task S72), and displays a page image based on page data of page 1 in the book data C on the display module 11 (task S73).

If the state determination module 13 determines that the mobile phone 1 is rotated downward (“YES” branch of the inquiry task S81), the control module 26 ceases to display the page image of the book data B (task S82), and displays a page image based on page data of page 3 in the book data A on the display module 11 (task S83).

If the state determination module 13 determines that the mobile phone 1 is not rotated (“NO” branch of inquiry task S46), the control module 26 detects whether or not the relative position of the second housing 4 to the first housing 2 changed (task S51). Detecting that the relative position shifted to any position other than the rotated position (“YES” branch of inquiry task S51), the control module 26 ceases to display the book data currently displayed (task S52).

In this manner, the user can, for example, display the next page or the previous page and can also change the book data to be displayed by rotating the mobile phone 1 by 180 degrees without inputting any command to display different pages by manipulating the touch panel 24/25 or the input module 22.

In an embodiment, a tilt angle of the mobile phone 1 to a horizontal plane (e.g., an angle between the Y-axis direction of the mobile phone 1 and the horizontal plane) can be calculated from values of acceleration components in the X-axis direction, Y-axis direction, and Z-axis direction detected by the acceleration sensor 14. The calculated tilt angle can be used to determine whether the display module 10 is over the display module 11, or the display module 11 is over the display module 10.

In one embodiment, it is determined whether the mobile phone 1 is rotated leftward, rightward, upward or downward. For example, the state determination module 13 determines whether the mobile phone 1 is rotated leftward, rightward, upward or downward by calculating a change per unit time of the tilt angle calculated by the acceleration sensor 14.

The mobile phone 1 may comprise two display modules, and can be rotated by 360 degrees instead of the 180-degree rotation.

If the mobile phone 1 is rotated rightward by an angle of rotation of approximately 360 degrees in the Y-axis direction with page 3 of the book data A being displayed on the display module 10 in FIG. 4, page 4 of the book data A can be displayed on the display module 10. If the mobile phone 1 is rotated leftward by approximately 360 degrees in the Y-axis direction with page 3 of the book data A being displayed on the display module 10, page 2 of the book data A may be displayed on the display module 10.

In the example described above, where the display module 11 is not used to display book data, a backlight of the display module 11 may be turned off, or an indication which encourages the user to further rotate the mobile phone 1 rightward through approximately 180 degrees may be displayed on the display module 11 when the mobile phone 1 was rotated rightward through approximately 180 degrees in the Y-axis direction.

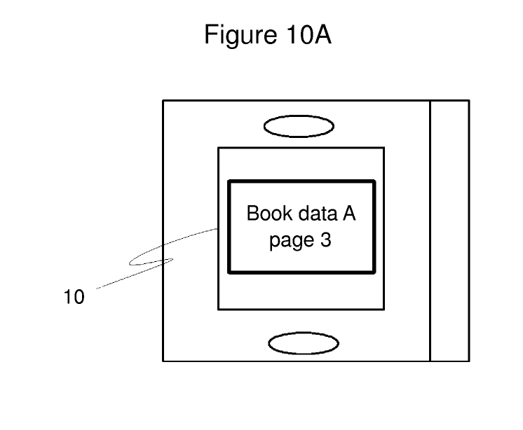

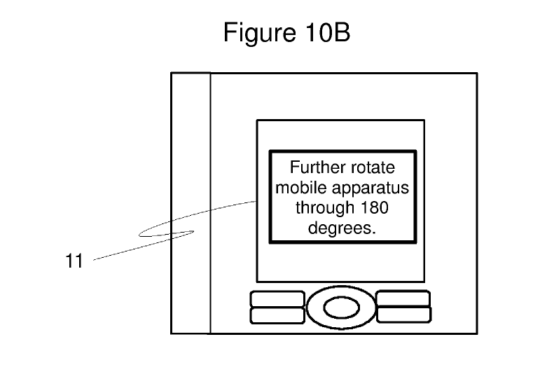

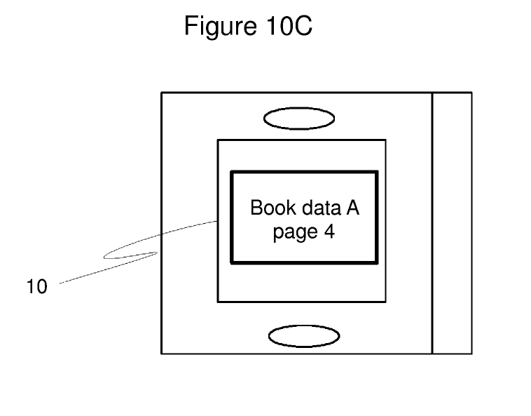

More specifically, a message illustrated in FIG. 10B may be displayed on the display module 11 if the user finished reading page 3 displayed on the display module 10 as shown in FIG. 10A and then rotated the mobile phone 1 rightward by approximately 180 degrees in the Y-axis direction. Then, page 4 is displayed on the display module 10 as shown in FIG. 10C when the mobile phone 1 displaying the message shown in FIG. 10B is further rotated rightward by approximately 180 degrees in the Y-axis direction.

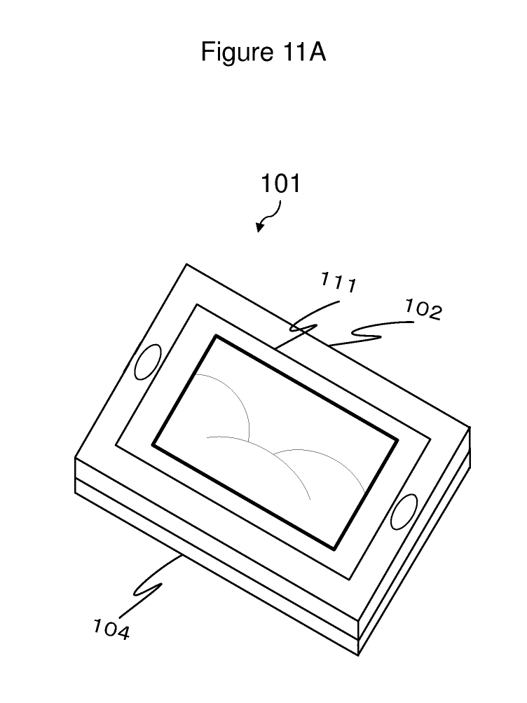

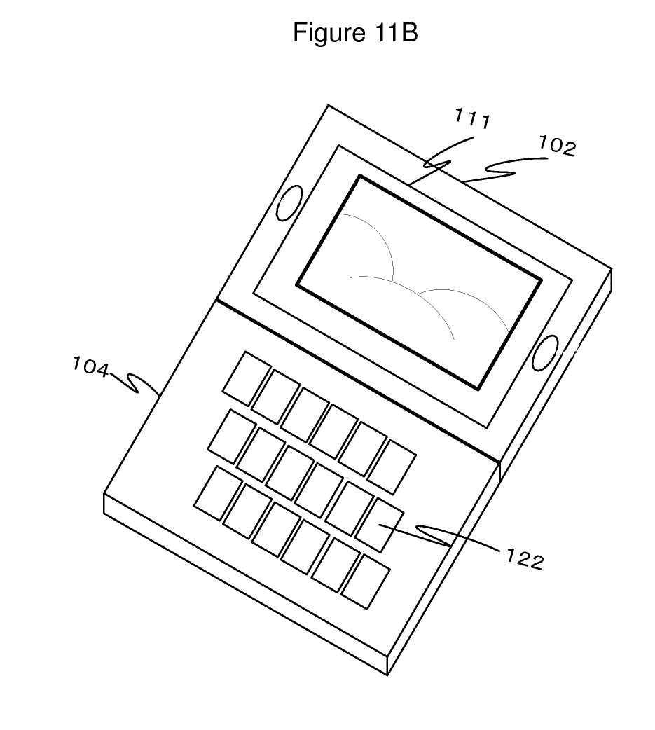

In an embodiment, the information of the book data A is displayed on one display module such as the display module 10. Thus, it is unnecessary to keep the display module 11 exposed at all times. In this manner, a slidable mobile phone 101 (mobile phone 101) shown in FIGS. 11A and 11B can be used as a mobile phone.

According to an embodiment, a latest received mail text can be displayed when the upward rotation is detected while the mobile phone 1 is displaying image data. More specifically for a first data and a second data comprised in a first group of data, if rotation in a first direction is detected during display of the first data, then the second data is displayed. Alternatively, when rotation in a second direction different from the first direction is detected during the display of the first data, then the display of the first data may be discontinued to display a second data comprised in a second group of data.

In the embodiments described above, if the mobile phone 1 changes position from the rotated position to the open position, the display of the page image is discontinued. Alternatively, a screen allowing the user to use more than one function provided in the mobile phone 1 is displayed on the display module 11 in place of discontinuing the page image display when the mobile phone 1 changes position from the rotated position to the open position while the display module 10 is displaying the page image of the book data B.

If the screen used to exert the functions is thus displayed on the display module 11, the user can select and use any function provided in the mobile phone 1 while viewing the page image. Examples of the screen used to exert the functions are a menu screen where a list of functions is displayed and a standby screen. The functions provided in the mobile phone 1 comprise, for example but without limitation, mail-related function (for example, creation of mail, sending of created mail, and display of received mail), television viewing, and camera functions in the case where an imaging device such as camera is provided therein, and the like.

According to the above embodiments, any inputs from either of the touch panels 24/25 are disabled via the operation control module if the display module 10/111 is displaying the page image. Alternatively, inputs from the touch panel 24/25 can be accepted if the mobile phone 1 changes position from the rotated position to the open position. In this manner, the user can access the functions displayed on the display module 11 by manipulating the touch panel 25. To enable the inputs through the touch panel 24/25, one of the display module 10 and the display module 11 or both of the display modules may be activated.

In an embodiment, the storage module 23 where the book data is stored, such as a memory card, may be inserted in the mobile phone so that the book data is obtained from the storage medium instead of the antenna 18.

In an embodiment, the mobile phone 1 can change display of the image data obtained by, for example, its built-in camera in a manner similar to turning pages of the book data.

FIGS. 11A to 11C are illustrations of image data displayed on the mobile phone 101. The mobile phone 101 may have functions, material, and structures that are similar to the mobile phone 1. Therefore common features, functions, and elements may not be redundantly described here.

The mobile phone 101 comprises a first housing 102 and a second housing 104, wherein the two housings are slidable. The first housing 102 comprises a display module 111 provided with a touch panel, and the second housing 103 comprises a group of operation keys 122. The two housings 102 and 104 are slid to use them accordingly. The group of operation keys 122 are hidden in a closed state (FIG. 11A), whereas they are exposed in a flat/open state (FIG. 11B) so that a user can use the operation keys.

If the state determination module 13 detects that the mobile phone 101 is rotated leftward while the display module 111 is displaying the image data (FIG. 10A), image data taken after the currently displayed image data may be displayed. If the state determination module 13 detects that the mobile phone 101 is rotated rightward while the display module 111 is displaying the image data, image data obtained earlier than the currently displayed image data can be displayed.

One rotation may be replaced with a sequence of actions where the mobile phone 1/101 is half-rotated and returned to its original position (0°→90°→0°) to turn pages.

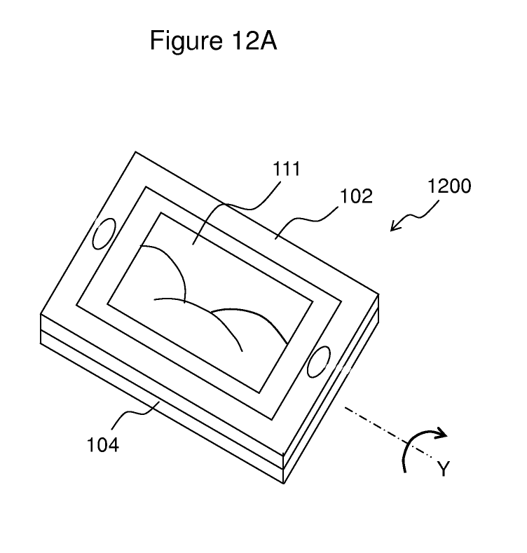

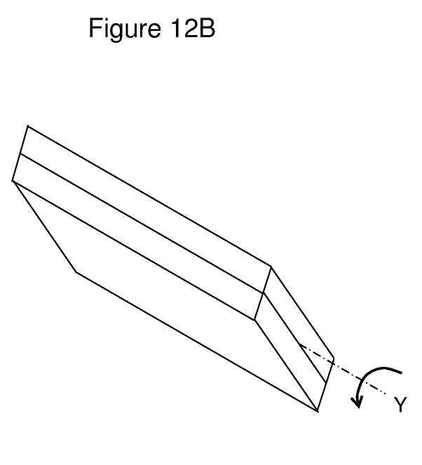

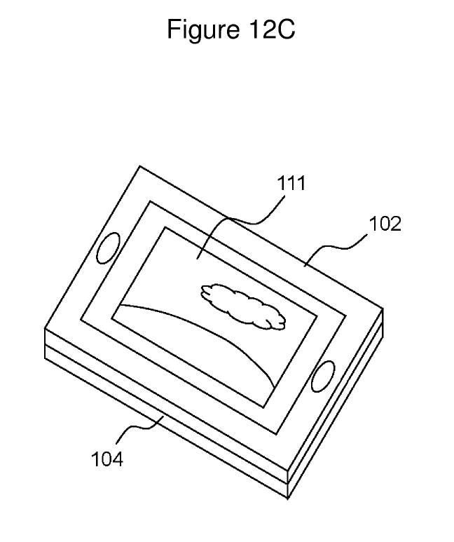

FIGS. 12A to 12C are illustrations of an example where a mobile phone is rotated rightward through 45° and then disposed horizontally again. FIG. 12A is a perspective view of a mobile phone 1200 according to an embodiment. FIG. 12B illustrates the mobile electronic device 1200 of FIG. 12A rotated rightward through 45°. FIG. 12C illustrates the mobile electronic device 1200 of FIG. 12B back to its original position.

The mobile phone 1200 shown in FIG. 12 may have functions, material, and structures that are similar to the embodiment shown in FIG. 11. Therefore common features, functions, and elements may not be redundantly described here.

FIG. 12A is an illustration of a landscape photograph. A user who wants to display an image of a next page rotates the mobile phone 1200 rightward through about 45° around a rotational axis Y to leave the mobile phone 1200 in the state of FIG. 12B. Then, the user reversely rotates the mobile 1200 leftward through about 45° (rightward rotation through −45°) to leave the device 1200 in the state of FIG. 12C which is its original state. Then, the next image is displayed.

Though not illustrated in the FIG. 12A-12C, the image displayed earlier can be displayed again when the mobile phone 1 is similarly rotated leftward through just 45° and then rotated rightward through 45°.

In this document, the terms “computer program product”, “computer-readable medium”, and the like may be used generally to refer to media such as, for example, memory, storage devices, or storage unit. These and other forms of computer-readable media may be involved in storing one or more instructions for use by the control module 26 to cause the control module 26 to perform specified operations. Such instructions, generally referred to as “computer program code” or “program code” (which may be grouped in the form of computer programs or other groupings), when executed, enable the displayed information protection method of the mobile electronic device.

While at least one exemplary embodiment has been presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being comprised within the scope of the present disclosure as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device comprising:
a first display module;
a second display module operable to change a relative position to the first display module;
a state determination module operable to determine a state of the mobile electronic device; and
a control module operable to display second page data on the second display module based on the state if first page data is displayed on the first display module.

2. The mobile electronic device according to claim 1, wherein a plurality of page data comprises the first page data and the second page data.

3. The mobile electronic device according to claim 2, wherein the first page data is different from the second page data.

4. The mobile electronic device according to claim 2, further comprising a storage module operable to store the page data.

5. The mobile electronic device according to claim 2, wherein the page data comprises at least one of the group consisting of: text data, image data, and video data.

6. The mobile electronic device according to claim 1, further comprising a light control module operable to turn off a light of the second display module, if first page data is displayed on the first display module.

7. The mobile electronic device according to claim 1, wherein the second page data is displayed on the second display module, if the first page data is displayed on the first display module, in response to the state determination module determining that the mobile electric device is rotated through at least an angle of rotation.

8. The mobile electronic device according to claim 1, wherein:
the state is determined based on a rotational direction of the mobile electronic device by detecting an acceleration of the mobile electronic device; and
the control module is operable to display the second page data on the second display module based on the acceleration, if the first page data is displayed on the first display module.

9. The mobile electronic device according to claim 1, wherein:
the state is determined based on a tilt angle of the mobile electronic device; and
the control module is operable to display the second page data on the second display module based on the tilt angle, if the first page data is displayed on the first display module.

10. The mobile electronic device according to claim 1, further comprising
a first housing comprising the first display module; and
a second housing comprising the second display module, wherein the control module is operable to display the first page data thereon, if the second housing and the first housing are in a simultaneously visible position; and
a display screen operable to execute functions provided in the mobile electric device on the second display module.

11. The mobile electronic device according to claim 1, wherein the first display module comprises:
a first touch panel; and
an operation control module operable to:
enable an operation inputted via the first touch panel, if the first page data is not displayed on the first display module, and
disable the operation if the first page data is displayed on the first display module.

12. The mobile electronic device according to claim 11, wherein:
the second display module comprises a second touch panel, and
the operation control module is operable to accept an operation inputted via the second touch panel, if a second housing comprising the second display module and a first housing comprising the first display module are in a simultaneously visible position.

13. A method of controlling a mobile electronic device, the method comprising:
determining a state based on a rotational direction and positional relation of the mobile electronic device; and
selecting a display for displaying data based on the state.

14. The method according to claim 13, further comprising:
determining the state based on a tilt angle of the mobile electronic device; and
displaying second page data on a second display module based on the tilt angle, if a first page data is displayed on a first display module.

15. The method according to claim 13, further comprising:
determining the state based on an acceleration of the mobile electronic device; and
displaying second page data on a second display module based on the acceleration, if the first page data is displayed on the first display module.

16. The method according to claim 13, further comprising:
enabling an operation inputted via a first touch panel, if a first page data is not displayed on a first display module, and
disabling the operation, if the first page data is displayed on the first display module.

17. The method according to claim 13, further comprising accepting an operation inputted via a second touch panel, if a second housing and a first housing are in a simultaneously visible position.

18. A computer readable medium comprising program code for operating an image display device, the program code for:
determining a state based on a rotational direction and positional relation of the mobile electronic device; and
selecting a display for displaying data based on the state.

19. The computer readable medium according to claim 18, further comprising program code for:
enabling an operation inputted via a first touch panel, if a first page data is not displayed on a first display module, and
disabling the operation, if the first page data is displayed on the first display module.

20. The computer readable medium according to claim 19, further comprising program code for accepting an operation inputted via a second touch panel, if a second housing and a first housing are in a simultaneously visible position.
